(19) United States
(12) Patent Application Publication
(10) Pub. No.: US 2015/0066617 A1
(43) Pub. Date: Mar. 5, 2015

(54) COMPUTER SYSTEM

(71) Applicant: Robert Choudhry, Ionia, MI (US)

(72) Inventor: Robert Choudhry, Ionia, MI (US)

(21) Appl. No.: 14/474,597

(22) Filed: Sep. 2, 2014

Related U.S. Application Data
(60) Provisional application No. 61/872,078, filed on Aug. 30, 2013.

(51) Int. Cl. G06Q 30/02; G06Q 30/06

(52) U.S. Cl. CPC G06Q 30/0217; G06Q 30/0633
USPC 705/14.19

(57) ABSTRACT

A computer system is provided that includes a website server configured to implement an e-commerce website and to interact with buyer web-enabled devices and seller web-enabled devices and is further configured to: transmit instructions to a payment server for payment of a review payment to be made to a buyer for writing a review of a purchased product/service; transmit instructions to a payment server for payment of a review payment to be made to a buyer for each review written by another buyer in the buyer's network; charge a fixed fee to a seller for each purchase order of the seller's products/services; and/or transmit instructions to a payment server for payment of a seller referral payment to be made to a seller for each purchase order from another seller in the seller's network.

### CROSS-REFERENCE TO RELATED APPLICATION

This application claims priority to and the benefit under 35 U.S.C. §119(e) of U.S. Provisional Patent Application No. 61/872,078, filed on Aug. 30, 2013, entitled “SYSTEM AND METHOD FOR INCREASING SELLER AND BUYER PARTICIPATION IN AN E-COMMERCE WEBSITE,” the entire disclosure of which is hereby incorporated herein by reference.

### BACKGROUND OF THE INVENTION

The present invention generally relates to computer systems and methods for operating computer systems to, for example, implement e-commerce websites.

E-commerce websites are well-known that provide an on-line marketplace for various sellers to sell products and services and for buyers to buy such products or services. Examples of such e-commerce websites include Amazon®, EBay®, and Alibaba.com®. Although these websites have proven to be successful, they do not provide much in the way of an effective referral system for referring both buyers and sellers to their websites. Thus, a need exists to improve upon the operation of the computer systems used to implement such e-commerce websites.

### SUMMARY OF THE INVENTION

According to an embodiment of the present invention, a computer system is provided that comprises a website server comprising a processor and a memory device, wherein the website server is configured to implement an e-commerce website and to interact with buyer web-enabled devices and seller web-enabled devices. The processor of the website server is further configured to: transmit data for a buyer profile input screen to a buyer's web-enabled device for display thereon; receive buyer profile information from the buyer's web-enabled device and store the buyer profile information in the memory device; transmit data for a listing of products/services for sale to the buyer's web-enabled device for display thereon; receive a purchase order from the buyer's web-enabled device for a purchased product/service; process the purchase order for the purchased product/service; subsequently transmit data for a review input screen to the buyer's web-enabled device for display thereon, where the review input screen pertains to a purchased product/service; receive a product/service review input on the purchased product/service from the buyer's web-enabled device; and transmit instructions to a payment server for payment of a review payment to be made to the buyer for writing a review.

According to another embodiment of the present invention, a computer system is provided that comprises a website server comprising a processor and a memory device, wherein the website server is configured to implement an e-commerce website and to interact with buyer web-enabled devices and seller web-enabled devices. The processor of the website server is further configured to: transmit data for a buyer profile input screen to a buyer's web-enabled device for display thereon; receive buyer profile information from the buyer's web-enabled device and store the buyer profile information in the memory device; enable the buyer to invite other buyers to join the e-commerce website whereby any buyers responding to an invite from the inviting buyer are identified in a network of the inviting buyer; transmit data for listings of products/services for sale to buyer web-enabled devices for display thereon; receive purchase orders from the buyer web-enabled devices for purchased products/services; process the purchase orders for the purchased products/services; subsequently transmit data for a review input screen to each buyer web-enabled device that was used to purchase a product/service for display thereon; receive product/service reviews input on a purchased product/service from the buyer web-enabled devices; and transmit instructions to a payment server for payment of a review payment to be made to the inviting buyer for each review written by a buyer in the inviting buyer's network.

According to another embodiment of the present invention, a computer system is provided that comprises a website server comprising a processor and a memory device, wherein the website server is configured to implement an e-commerce website and to interact with buyer web-enabled devices and seller web-enabled devices. The processor of the website server is further configured to: transmit data for a seller profile input screen to a seller's web-enabled device for display thereon; receive seller profile information from the seller's web-enabled device and store the seller profile information in the memory device; receive product/service information from the seller's web-enabled device; cause a listing of products/services for sale of the seller's products/services to be displayed on the buyer web-enabled devices; receive purchase orders from the buyer web-enabled devices for the seller's products/services; process the purchase orders; and charge a fixed fee to the seller for each purchase order of the seller's products/services.

According to another embodiment of the present invention, a computer system is provided that comprises a website server comprising a processor and a memory device, wherein the website server is configured to implement an e-commerce website and to interact with buyer web-enabled devices and seller web-enabled devices. The processor of the website server is further configured to: transmit data for a seller profile input screen to a seller's web-enabled device for display thereon; receive seller profile information from the seller's web-enabled device and store the seller profile information in the memory device; enable the seller to invite other sellers to join the e-commerce website whereby any sellers responding to an invite from the inviting seller are identified in a network of the inviting seller; transmit data for listings of products/services for sale to buyer web-enabled devices for display thereon; receive purchase orders from the buyer web-enabled devices; process the purchase orders; and transmit instructions to a payment server for payment of a seller referral payment to be made to the inviting seller for each purchase order from a seller in the inviting seller's network.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is an electrical circuit diagram in block form of a computer system in which the embodiments of the present invention may be implemented;

FIG. 2 is an electrical circuit diagram in block form of the structure of a website server in which the embodiments of the present invention may be implemented;

FIG. 3 is a flow chart showing operations of the website server when setting up a buyer's profile;

FIG. 4 is a flow chart showing operations of the website server when setting up a seller's profile; and

FIGS. 5A and 5B together represent a flow chart showing operations of the website server when creating product listings and when receiving and processing purchase orders.

### DETAILED DESCRIPTION OF THE EMBODIMENTS

Reference will now be made in detail to the present preferred embodiments of the invention, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

The embodiments described herein generally pertain to a computer system and a method for improved operation of a computer system. Such a computer system may be used, for example, to provide an e-commerce website. The novel features of the inventive system and method will be described below.

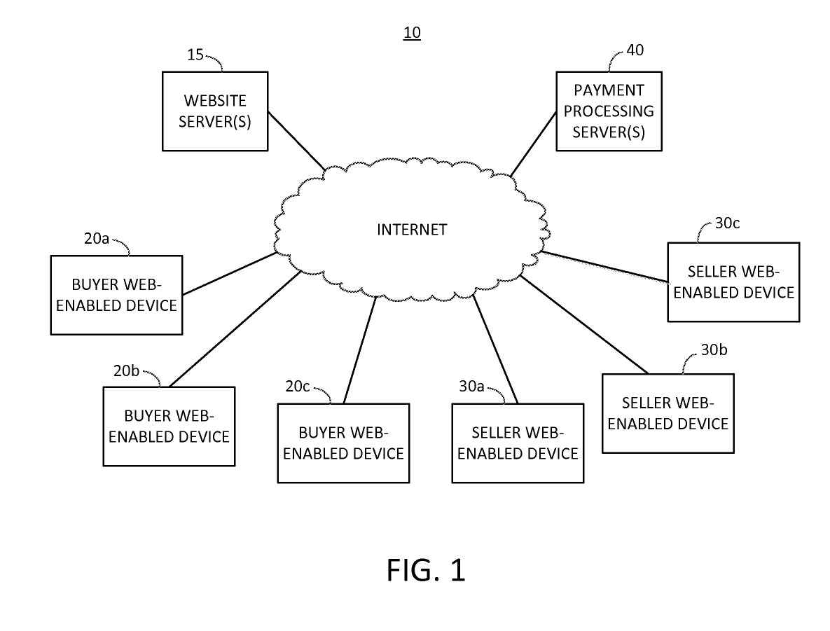

An example of a computer system 10 for implementing an e-commerce website is shown in FIG. 1. As shown, the computer system 10 includes a website server 15 configured to interact with various buyer web-enabled devices 20a-20c and seller web-enabled devices 30a-30c through the Internet. Such web-enabled devices may include personal computers, laptops, tablets, smart phones, etc. Website server 15 may also be configured to interact with other servers such as one or more a payment processing servers 40, such as PayPal®.

Although only one website server 15 is shown, additional servers may be provided to accommodate the number of users and volume of transactions. Further, although only three each of web-enabled devices 20a-20c and 30a-30c are shown, considerably more web-enabled devices would be able to interconnect with website server(s) 15.

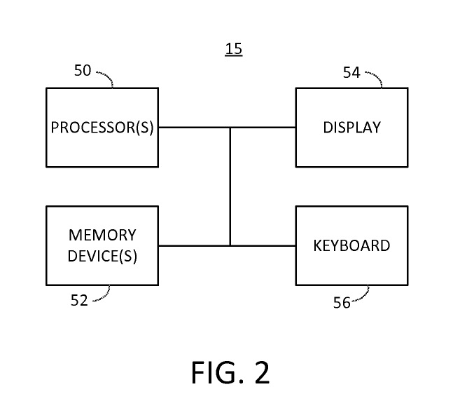

FIG. 2 shows an example of the structure of website server 15. As shown, website server 15 may include one or more processors 50 and one or more memory devices 52. The server may also include a display 54 and various user input devices including, for example, a keyboard 56. Website server 15 may be constructed using known hardware; however, such hardware is modified by storing and executing novel software that transforms the hardware of website server 15 into a specialized machine that performs novel functions. Thus, the computer system described herein exhibits improved operation to implement such an e-commerce website. Such improved operations include the manner in which website server 15 interacts with other web-enabled devices 20a-20c and 30a-30c and servers 40 and facilitates interactions between these other devices and servers.

Website server 15 is configured to interact with buyer web-enabled devices 20a-20c and seller web-enabled devices 30a-30c, and processor 50 is preferably configured by appropriate programming to: cause a buyer profile input screen to be displayed on buyer web-enabled devices 20a-20c; receive buyer profile information from the buyer web-enabled devices 20a-20c and store the buyer profile information in memory device 52; enable the buyers to invite other buyers to join the e-commerce website whereby any buyers responding to an invite from a buyer are identified in a network of that buyer; cause a seller profile input screen to be displayed on seller web-enabled devices 30a-30c; receive seller profile information from the seller web-enabled devices 30a-30c and store the seller profile information in memory device 52; enable the sellers to invite other sellers to join the e-commerce website whereby any sellers responding to an invite from a seller are identified in a network of that seller; receive product/service information from the seller web-enabled devices 30a-30c; cause listings of products/services for sale to be displayed on buyer web-enabled devices 20a-20c; receive purchase orders from the buyer web-enabled devices 20a-20c; process the purchase orders; charge a fixed fee to each seller for each purchase order of that seller's products/services; cause payment of a seller referral payment to be made to a seller for each purchase order from another seller in that seller's network; subsequently cause a review input screen to be displayed on each buyer web-enabled device 20a-20c that was used to purchase a product/service; receive product/service reviews input on a purchased product/service from the buyer web-enabled devices 20a-20c; cause payment of a review payment to be made to each buyer for writing a review; and cause payment of a review payment to be made to a buyer for each review written by another buyer in that buyer's network.

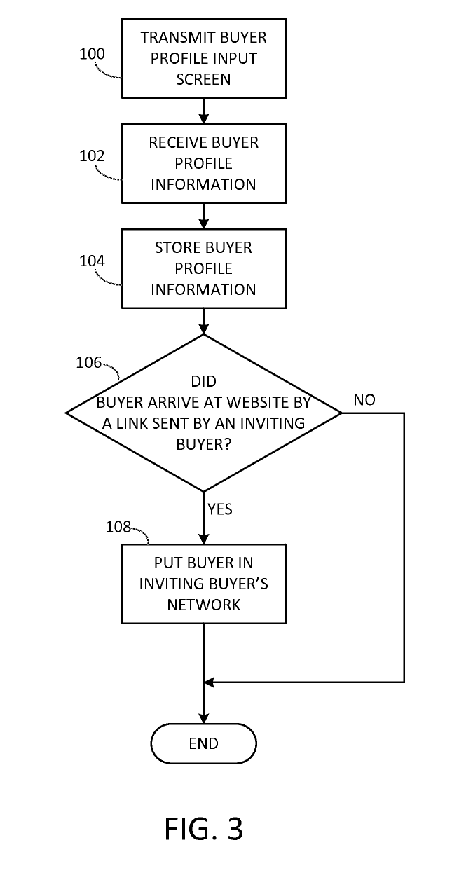

FIG. 3 is a flow chart showing operations of the website server 15 when setting up a buyer's profile. As shown, the operation begins with step 100 in which processor 50 of website server 15 transmits data for a buyer profile input display screen to a buyer's web-enabled device 20a-20c for display thereon. Next, in step 102, processor 50 receives buyer profile information from the buyer's web-enabled device 20a-20c and, in step 104, stores the buyer profile information in memory device 52. The website server enables a buyer (e.g., an “inviting buyer” whose profile was already set up) to invite other buyers to join the e-commerce website, by generating a link (also referred to below as “a special invite link”) that the inviting buyer may send to potential buyers. If those potential buyers subsequently join the website, they are placed in the inviting buyer's network. Thus, in step 106, processor 50 may determine whether the buyer whose profile information was just received and stored arrived at the e-commerce website by way of a link that was sent by an inviting buyer. If the buyer did arrive via such a link, processor 50 automatically places the buyer in the inviting buyer's network in step 108. Otherwise, step 108 is skipped. It should be noted that any registered buyer may invite other buyers who are then placed in that inviting buyer's network.

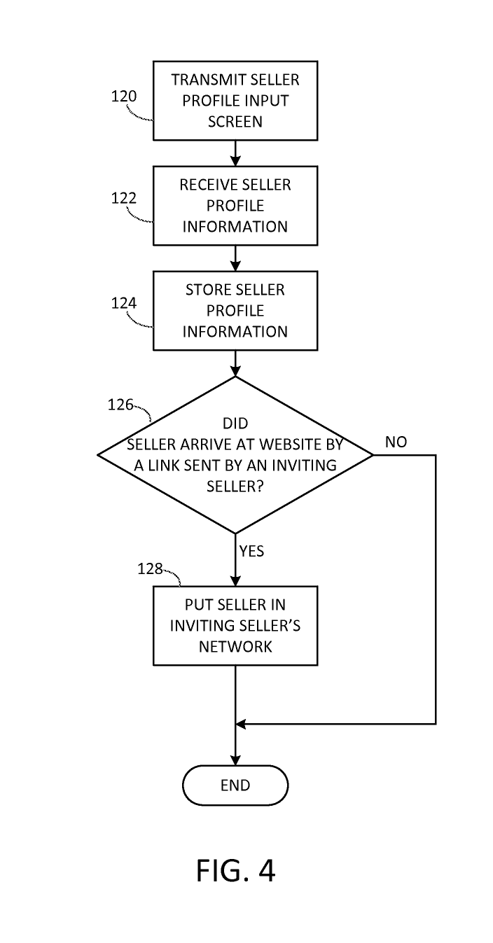

FIG. 4 is a flow chart showing operations of the website server 15 when setting up a seller's profile. As shown, the operation begins with step 120 in which processor 50 of website server 15 transmits data for a seller profile input display screen to a seller's web-enabled device 30a-30c for display thereon. Next, in step 122, processor 50 receives seller profile information from the seller's web-enabled device 30a-30c and, in step 124, stores the seller profile information in memory device 52. The website server enables a seller (e.g., an “inviting seller” whose profile was already set up) to invite other sellers to join the e-commerce website, by generating a link (also referred to below as “a special invite link”) that the inviting seller may send to potential sellers. If those potential sellers subsequently join the website, they are placed in the inviting seller's network. Thus, in step 126, processor 50 may determine whether the seller whose profile information was just received and stored arrived at the e-commerce website by way of a link that was sent by an inviting seller. If the seller did arrive via such a link, processor 50 automatically places the seller in the inviting seller's network in step 128. Otherwise, step 128 is skipped. It should be noted that any registered seller may invite other sellers who are then placed in that inviting seller's network.

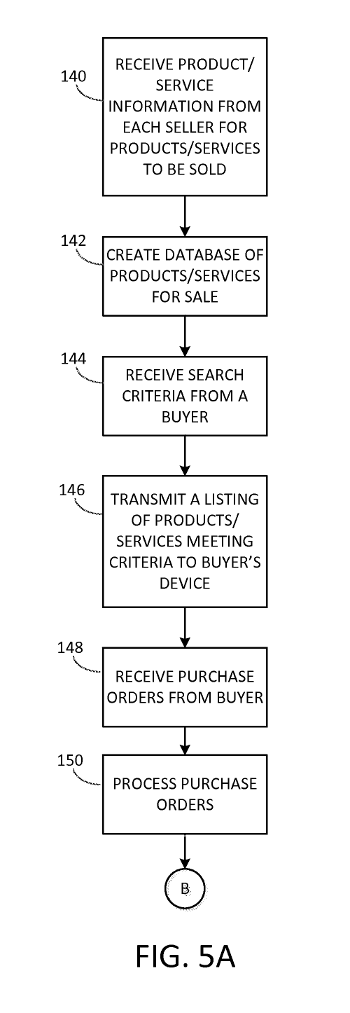

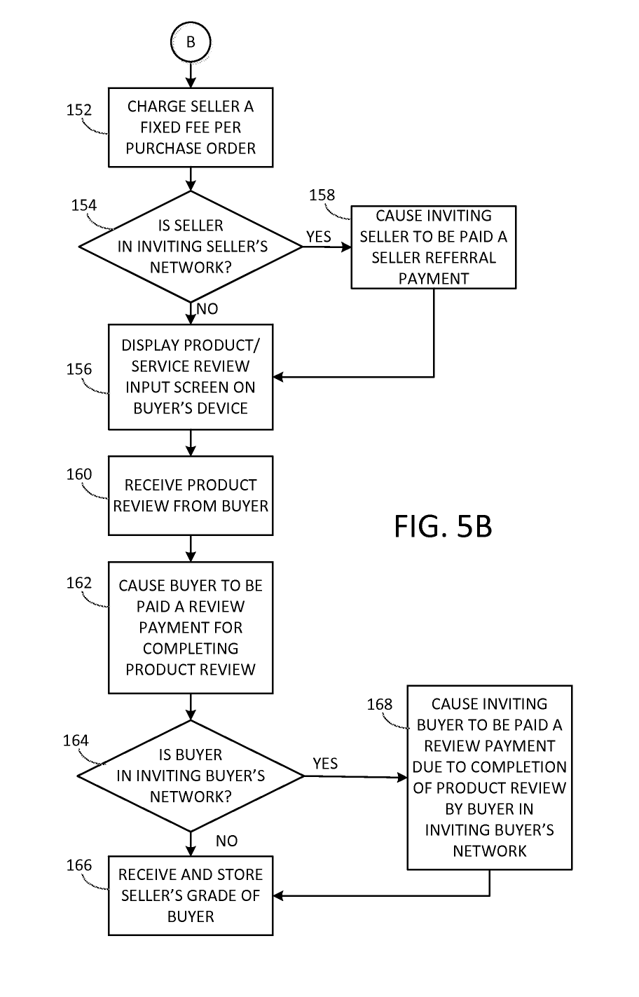

FIGS. 5A and 5B together represent a flow chart showing operations of the website server 15 when creating product listings and when receiving and processing purchase orders. This process begins in step 140 (FIG. 5A) wherein processor 50 of website server 15 receives product/service information from each seller for products/services to be sold. Such information may be continuously received as new sellers join the website and existing sellers expand their product/service offerings. Then, in step 142, processor 50 creates or adds to a database of products/services for sale. This database is maintained in memory device 52 and is accessible to all buyers who may submit search queries to website server 15. Thus, in step 144 processor 50 may receive such a search query having search criteria from a buyer who may be looking for a particular product or service. Processor 50 responds in step 146 by transmitting data for a listing of products/services meeting the search criteria to the buyer's web-enabled device 20a-20c for display thereon. The buyer may then browse through the listing and place one or more purchase orders (step 148). Processor 50 responds in step 150 by processing the purchase order(s). This may involve accepting payment from the buyer on behalf of the seller, notifying seller of the purchase order so that the seller may fulfill the order, and confirming the order with the buyer. Payment may be made to a PayPal® account of the seller or to an account of the website operator who then transfers some of the money to an account of the seller minus a flat fixed fee as indicated in step 152 (FIG. 5B). Then, in step 154, processor 50 determines if the seller is in an inviting seller's network. If not, processor 50 proceeds to step 156 in which processor 50 transmits data for a product/service review input screen to the buyer's web-enabled device 20a-20c for display thereon, wherein the review input screen pertains to the purchased product/service. If the seller is in an inviting seller's network, processor 50 causes the inviting seller to be paid a seller referral payment in step 158 before proceeding to step 156. To do this, processor 50 may transmit instructions to payment server 40 for payment of the seller referral fee to be made to the inviting seller.

In step 160, processor 50 receives a product review from the buyer. Processor 50 responds by posting the review relative to the product for other buyers to see and transmits instructions to payment server 40 for payment of a review payment to the buyer for writing the review in step 162. The processor 50 then determines if the buyer is in an inviting buyer's network in step 164. If not, processor 50 proceeds to step 166. If yes, the processor transmits instructions to payment server 40 for payment of a review payment to the inviting buyer. In step 166, processor 50 prompts the seller to grade the buyer and receives and stores the seller's grade of the buyer. As explained further below, other sellers may see the cumulative grades of the buyers when deciding whether to do business with them.

Insofar as some of the improved functions outlined above and described in more detail below are embodied in software that includes instructions to be executed by the processor(s) 50, it will be appreciated that the present invention may be embodied in any form of computer readable medium having stored thereon the software that is executed by the processor(s) to cause the processor(s) to perform the steps set forth above and described further below.

Having generally described the structure and some basic functions of the inventive computer system, several examples are described below that further illustrate the functions and features of the system as well as the advantages offered by the computer system.

On the e-commerce website homepage, there may be three sign-in portals. These portals will present sign-ins for VIP, business member, and entrepreneur OTGP. As used herein, a “VIP” is a buyer (or shopper) of the general public, a “business member” is a seller selling online via the e-commerce website or offline at a physical location, and an “entrepreneur OTGP” is an on-the-ground partner/entrepreneur looking for business opportunities with sellers.

Preferably, anybody can become a VIP or business member or OTGP for free. The OTGP is simply a free perk for sellers to find people who may be interested in selling their products or services in the local countries or markets of OTGPs.

There are two ways for a VIP or seller to join the e-commerce website:

1. Go to the homepage of the e-commerce website and simply click on the join form to fill out the simple form and clicking submit. They can choose to be a VIP or seller. It is preferably 100% free. By filling out the join form, the VIP buyer or seller is filling out part of their profile.

2a. An existing VIP emails a special invite link to any person in the world. When the receiver of this special invite link clicks on the link, he/she fills out a simple form and clicks submit, now this new person is a VIP too. This new VIP is now in the VIP network of the VIP who had sent the special invite link. This will be explained further below in the examples to follow.

2b. An existing seller emails a special invite link to any business owner in the world (this can be an online or offline business owner). When the receiver of this special invite link clicks on the link, he/she fills out a simple form and clicks submit, now this new business owner is a seller too. This new seller is now in the business network of the seller who had sent the special invite link. This will also be explained further below in the examples to follow.

First, before getting into the specific examples, let us say three sellers joined the e-commerce website:

1. Tom lives in Chicago and sells baby toys online. He has come to the e-commerce website homepage and joined via the homepage. He has opened his store of “Tom's Baby Toys” and uploaded 2300 products.

Unlike Amazon and EBay which will charge sellers with listing fees, closing fees, and monthly subscriptions fees for stores, the inventive e-commerce website preferably does not charge anything, Tom's cost for his store at the e-commerce website is zero. Unlike Amazon which will charge a commission on each and every item sold by Tom, the inventive e-commerce website will charge him zero. If Tom sells 25 items in an order at Amazon, Tom will have to pay a commission to Amazon on each of those 25 items, thus Amazon gets paid 25 fee payments on those 25 items sold by Tom.

If Tom sells those 25 items at the inventive e-commerce website, Tom will not pay any fee on each item. Instead Tom pays only a flat checkout fee. This checkout fee can be changed at any time in the future without affecting the innovative process of the inventive e-commerce website. This may be a flat checkout fee of $20 so it does not matter if Tom gets an order of $100, $500, $10,000, $50,000, $100,000, $1 million or $10 million, the checkout fee is still only $20 in each case no matter how big an order.

If Tom sells 20 items in an order or 200 items on an order, the checkout fee is still the same flat fee of $20 because the inventive e-commerce website does not charge Tom on each item he sells.

2. Mary owns a hair salon in Florida and is a friend of Tom's. Tom had told Mary about how great the inventive e-commerce website is and that she should join too. Tom emailed a special invite link to Mary. Mary clicked on the special invite link sent by Tom, filled out the join form and now Mary is in the business network of Tom. Mary has opened her store on the inventive e-commerce website of “Mary's Hair Salon.” Because Mary is an offline business, she does not sell anything online. She only issues VIP tickets in her VIP store. She has issued 100 VIP tickets in her store. This VIP ticket says “10 Fancy Haircuts (men or women) for $70 ($7 per haircut). The regular price of a fancy haircut is $20. We are offering it for $7 only for VIPs. Includes shampoo and free sample shampoo to take home.” Any VIP can “grab” this VIP ticket from the VIP store of Mary's Hair Salon. Since Mary has issued 100 VIP tickets in her store, 100 VIPs can grab a ticket or any VIP can grab more than 1 ticket.

To “grab” a ticket, a VIP simply buys it for $70 and takes the ticket with them when they go to Mary's Hair Salon to get the $7 fancy haircut (normally these haircuts cost $18). Since this is a package deal of 10 haircuts, the VIP can use this ticket for months or as long as it takes him/her to get all 10 haircuts. This purchase of 10 fancy haircuts for $70 counts as one purchase, not 10 purchases because one VIP ticket was “grabbed” by the VIP so he/she could save money.

3. Tom also has a friend named John who lives in Australia and sells sheep wool clothing items online. Tom also told John about the inventive e-commerce website and emailed the special invite link to John. John clicked on this link and filled out the join form, and is now in the business network of Tom. Thus so far three sellers have joined the inventive e-commerce website: (1) Tom—from Chicago—sells baby toys online; (2) Mary—from Florida—sells haircuts offline; and (3) John—from Australia—sells sheep wool clothing online.

Tom had invited Mary and John so this means Mary and John are in the business network owned by Tom. This means Tom has two sellers in his business network.

Now, over the next 6 months, Tom has grown his business network to 100 sellers in his business network. These 100 sellers are located all over the USA and also in other countries, they are a mix of online and offline sellers. Tom can keep growing his business network forever; he can grow it to any number of sellers because there is no limit. But, let us say he has 100 sellers so this makes it easier to explain.

Mary also has spent time sending her own special invite link to her friends and contacts who are business owners. After 6 months, Mary has grown her business network to 60 sellers.

John also has spent time sending his own special invite link to his friends and contacts who are business owners. After 6 months, John has grown his business network to 400 sellers.

Now there is a new seller named Jim who joined via the e-commerce website homepage. He sells custom-made car stereos online. Jim has not sent a special invite link to anybody yet thus he has zero sellers in his business network.

In summary: Tom, who joined at the homepage, has a business network of 100 sellers; Mary, who joined from a link sent by Tom, and has a business network has 60 sellers; John, who joined from a link sent by Tom, and has a business network has 400 sellers; and Jim, who joined at the homepage, has a business network and has zero sellers. This means that Tom and Jim are not found in the business network of anybody because they were never sent a special invite link by any seller. Instead, Tom and Jim joined the inventive e-commerce website by signing up at its homepage.

Jim has no sellers in his business network so the only income he makes at the inventive e-commerce website is when he sells his custom stereo systems to VIPs. And because Jim joined from the homepage, he is not in anybody's business network. Only Mary and John are found in a business network because they were sent a special invite link from Tom, thus both Mary and John are the business network owned by Tom. Mary and John signed up via the link sent by Tom.

Having explained how sellers will join the inventive e-commerce website, the manner by which shoppers will join and become VIPs will be explained.

Matt comes to the inventive e-commerce website homepage, fills out the short form, clicks the register me button, and instantly Matt has become a VIP. Matt likes the concept very much and can see how he and his family can benefit from saving money, and especially from the VIP network. Matt tells his friends and family about the inventive e-commerce website and emails them a special invite link. Matt sends this link to four people and all four people join: Don, Larry, Susan, and Linda. Thus, now Matt has four VIPs in his VIP network.

Don has grown his own VIP network to well over 500 people from all over the USA and the world. Don invited friends, family, contacts, friends of friends, people he met on his travels, etc. But, over one year, Matt also grew his VIP network to 600 people.

In summary, Matt has 600 VIPs in his VIP network. Matt joined from the VIP homepage. Don has 500 VIPs in his VIP network. Don joined via the link emailed by Matt.

### Example 1

Matt signs in at the inventive e-commerce website and browses the many VIP stores. He finds a sheep wool jacket he likes. Matt buys it for $100 from the seller, who is John from Australia. The normal price is $180, but John sells it for $100 exclusively to VIPs through the inventive e-commerce website site. Matt is happy because he saved $80. John is happy because he just sold a sheep wool jacket to Matt in Michigan. John has to pay the PayPal fee of 2.9%+30 cents on his sale to Matt. Thus, John's fee to PayPal will be $3.78 on a sale of $120+($100 for the jacket+$20 shipping). Because 2.9%+30 cents of $120 is the $3.78 fee due to PayPal from John.

As soon as Matt made this purchase of $100, the $20 checkout fee was deducted by the operator of the inventive e-commerce website and then the website server 15 did the following actions: (1) paid $80+$1.89 to John (thus John got payment of $81.89 because the operator of the inventive e-commerce website gave John the extra $1.89 because the inventive e-commerce website will pay 50% of the PayPal fees for all its sellers on all their orders of $200 and less, which is a huge help to sellers who sell a high quantity of items every month); paid $5 to Tom because John is in the business network of Tom; and (3) paid $5 to Matt as soon as he writes his review (Matt got his jacket two weeks later and wrote a review such as: “I love this jacket for the cold winters in Michigan. John was great to work with, thanks again!” and as soon as Matt clicked on “Submit this Review,” Matt was paid $5). Even though Tom was not involved in this sale of a sheep wool jacket from John in Australia to Matt in Michigan, the inventive e-commerce website will still pay $5 to Tom because it is Tom who had sent the special invite link to John in Australia, which John clicked on to join and was automatically placed in the business network belonging to Tom.

John, the seller from Australia, reads the review and can reply or not but would give Matt a grade as a customer of either A+, B, C or F.

The inventive e-commerce website need not take any advertising at all. If any business wants to get promoted to our many VIPs, it may grant wishes of our VIPs. VIPs with low grades like an F means they are less likely to get their wishes granted because F means that the VIP is a difficult person/customer or impossible to please customer who sellers do not like to deal with. This will help to make sure all VIPs treat all sellers with respect and kindness.

If any business wants to be marketed or promoted to the many VIPs, they are asked to: don't spend your money on advertising because we do not take any advertising, instead spend your advertising money on granting the wishes of our VIPs.

For example, Matt has some 90 wishes in his VIP profile. One of these wishes is to take his parents on a cruise. The cost is $2500. A seller in California who sells wine has granted this wish of Matt's. In exchange for granting Matt's wish, all 600 VIPs in Matt's network are informed that this California winemaker “has just granted a wish of Matt's. And we love sellers who grant wishes of our VIPs! Please visit their VIP store at (link) to show your support for their kindness!” As a result, the winemaker could get a lot of orders from Matt's VIP network of 600 VIPs.

On the inventive e-commerce website site, there is also a special search engine to find sellers by the ones who have granted the most wishes. One can narrow search results by: (1) country; (2) region; (3) state; (4) county; (5) city; and/or (6) ZIP code. This way the most generous sellers get special placement and promotion to the VIP community. The more wishes that a seller grants, the higher they are ranked in the “most-generous” search results. One can also narrow search results in this exact same manner of five ways when searching for any products or services, online and offline. Likewise, the sellers can also narrow search results in the exact same five ways when searching for VIPs (potential customers).

### Example 2

Don signs in at the inventive e-commerce website and grabs the haircut deal at Mary's Hair Salon in Florida. Don “grabs” the $70 VIP ticket to get 10 fancy haircuts for $7 each. As soon as Don “grabbed” the VIP Ticket, the inventive e-commerce website server 15 took the following actions: (1) paid $50+$1.17 to Mary the owner (the extra $1.17 is to pay Mary 50% of her PayPal fees); (2) paid $5 to Tom (because Mary's Hair Salon is in the business network owned by Tom); paid $5 to Don (after Don comes home and writes a review about his haircut, and clicks submit); and (4) paid $5 to Matt (as soon as Don submits his review about Mary's Hair Salon because Don is a VIP in the VIP network owned by Matt). Keep in mind, Matt has 600 VIPs in his VIP network who are VIPs from across the USA and the world—all people Matt has sent a special invite link to via email.

The key to help millions of people in the USA and the world will happen as follows:

Tom has 100 sellers in his business network. Let's say these 100 sellers make an average number of 60 sales each per month. That is 100×60=6,000 sales per month from the business network that Tom owns. The inventive e-commerce website pays Tom $5 every time every business in his business network makes a sale to any VIP! Tom is making great income for doing nothing! From his business network, Tom in Chicago is making $30,000 per month. Tom's own toy store on our VIP site is making him around $5,000 per month. But Tom's business network is making him $30,000 per month. Thus, Tom is enjoying two income streams per month from the inventive e-commerce website.

Matt has 600 VIPs in his VIP network. Let's say these 600 VIPs make an average number of five purchases per month (online and offline). That is 600×5=3,000 purchases per month from the VIP network that Matt owns. That means 3,000 reviews are being submitted by Matt's VIP network every month. The inventive e-commerce website pays Matt $5 every time every VIP in his VIP network submits a review about any seller. Matt is making great income for doing nothing! From his VIP network, Matt in Michigan is making $15,000 per month. Matt has a day job of being an attorney that brings him an income of $10,000 per month. But Matt's VIP network is making him $15,000 per month. Thus, Matt is enjoying an extra income stream from the inventive e-commerce website.

Both Tom and Matt can keep on growing their business network (of Tom) and VIP network (of Matt) to any size, there's no limit. Tom and Matt will enjoy the income streams from the business network or VIP network for life, it will be a constant source of income forever or for as long the inventive e-commerce website is in existence.

Here are a few more examples of why shoppers will prefer the e-commerce website:

### Example 3

A retired couple has no income other than their monthly social security check. They joined the inventive e-commerce website and have managed to send an email to friends in various states, and even relatives far away in Italy. This couple has 70 VIPs in their VIP network. In fact, the husband has his own VIP network of 40 VIPs and the wife has 30 VIPs in her VIP network. These combined 70 VIPs make around 500 purchases per month. The retired couple gets paid $5 from the inventive e-commerce website every time the reviews are submitted for these 500 purchases, thus 500×$5=$2500 in income per month to this retired couple which is much more than their social security check.

### Example 4

Emily comes from a poor family, they never buy online. But she wants to help her family and has been promoting the site to her friends online. Emily now has 150 VIPs in her VIP network who average two purchases per month per VIP thus 150 VIPs×2=300 reviews submitted per month from Emily's VIP network×$5=Emily gets $1500 per month from the inventive e-commerce website. It is a huge help to her family.

### Example 5

Amy does not really have any spending money left after bills, so she may purchase something at the inventive e-commerce website once in a while. She averages around four purchases per year, so she made $20 for the whole year because four purchases means four reviews×$5 paid to her by the inventive e-commerce website as soon as she submits her review. However, Amy's husband is a truck driver who travels the USA and makes friends to whom he emails Amy's link. He does not want to be a VIP but he helps Amy grow her VIP network. These people across the country like the idea and click on the special invite link of Amy and sign up, which puts them automatically in Amy's VIP network. Amy has 300 VIPs in her VIP network who make a purchase at an average rate of four times per month=300×4=1200 purchases and reviews submitted per month from Amy's network. Amy gets paid 1200×$5 by the inventive e-commerce website, thus Amy makes $6,000 per month. Amy herself only made $20 for the four reviews she wrote in the whole year, but she made $72,000 for the whole year from her VIP network of 300 VIPs.

Amy and her husband have been able to pay off their home thanks to the inventive e-commerce website.

In the above scenarios, there are two types of sellers. One is a parent seller like Tom from Chicago. He is a parent seller because he joined at the homepage and is not in anybody's business network. The second is a child seller, like Mary from Florida, because she has Tom as her parent seller since she is in the business network of Tom's. Whenever Mary makes a sale to any VIP, Tom gets paid $5. Mary too can grow her own business network and get paid $5 every time every seller in her business network makes a sale to any VIP. Tom does not get any benefit from Mary's business network because that belongs to Mary only.

And two types of VIPs. The first is a parent VIP like Matt from Michigan. Matt is a parent VIP because he joined at the homepage and is not in anybody's VIP network. The second is a child VIP like Don because he is in the VIP network of Matt because Don joined the inventive e-commerce website from a special invite link that places Don in Matt's VIP network.

Another feature for sellers is called “Sister Merchants” where the sellers can cooperate with each other to send VIP leads to each other, share customers, help each other make sales, place each other's products in each other's stores (online and offline), which is great if they are located in opposite ends of the USA.

### Example 6

Terry hears about the inventive e-commerce website and comes to its homepage. Terry registers himself at the homepage to become a VIP instantly for free. Terry creates his VIP profile and lists his interests and that he's a truck driver. Terry signs in to the inventive e-commerce website and goes to his VIP desk. Terry clicks on online shopping. Terry can shop by keyword if he knows what he is looking for. Or he can shop by location is he does not know what he wants to buy, but just wants to see what VIP sellers are offering who are based in any certain area. Terry decides to shop by keyword so he enters “leather jacket.” He is by default searching the USA because that is where he is based, but he can search in any country. The results come up for 16,000 leather jackets in the USA. Terry can now narrow down the search results by region, state, county, city, and/or ZIP code. Terry narrows it down to Kent County in Michigan, so now he can see the search results of 35 leather jacket sellers who are located only in Kent County in Michigan. Both online and offline sellers must enter their location when they create a VIP store. Even though Terry is shopping online, he prefers that the seller be closer to him. Terry can further refine the search to see only those jackets that are MADE IN USA (he could have done this on the 16,000 results too). Terry could have chosen any country, like MADE IN GERMANY so he can find all leather jackets from sellers in the USA that sells jackets made in Germany. Terry looks at the 35 business profiles to see which seller he likes the most and which leather jacket he wants. Only seven are made in USA. Terry buys the jacket. At the same time, the seller is notified in his business desk that he just got an order. As soon as Terry buys the jacket, the 80s clothing shop gets paid $5 by the inventive e-commerce website because the Fancy Jackets Store is in the business network of 80s clothing shop. Terry gets the jacket and writes a review from Fancy Jackets Store (it's owned by Jim). Terry says: “I love this Jacket and am glad to be supporting Made in USA.” As soon as Terry submits that review, he gets paid $5 by the inventive e-commerce website.

Jim replies to the review “Thanks Terry for your business would love to serve you again soon!” Jim gives Terry a Grade of A+. It means the customer was great for the seller. If a shopper gets an F, this lets sellers know that this guy is a trouble-maker, impossible to satisfy, and the seller will be much less likely to grant any of the wishes of those VIPs who have an F grade. The grade on any VIP profile is determined by which grade the majority of sellers gave them. So one can have 90 A+'s and 10 F's but your VIP profile is labeled A+ because 90% have given that grade. Terry is happy to get the A+.

Terry has been a VIP for six months and he has 300 VIPs in his VIP Network from all over the USA and the world. Terry also has 234 wishes. One day a seller from Canada contacts Terry and offers to grant his wish of “I wish for a new transmission for my car.” The Canadian seller grants his wish and Terry is very happy! The Canadian seller sells Canadian hot sauce. He has granted a wish of Terry's so now Terry has allowed him access to his 300 VIPs in his VIP network. A seller gets one access per one wish. Thus, the seller sends an email letter to all 300 VIPs, saying: “Hello we make the best hot sauce to keep things hot in cold Canada etc. etc., here is our link to our VIP Store, give our home-made sauces a try today!” The seller may get 80 orders and many repeat customers. The letter the seller wrote above is a fixed text that cannot be altered or a default text such as: “Dear VIPs, here below is a letter from one of our sellers who just granted a wish of Terry's! We love to give special attention to sellers who grant wishes of our VIPs! Please show your support and visit their store after reading their letter below!”

Terry is happy with his new jacket, new transmission and his ongoing income from his VIP network (300 VIPs) and his 300 VIPs make an average purchase of three times per month. 300×3=900 reviews submitted. 900×$5=Terry is making $4500 per month for doing absolutely nothing. Terry can also search VIP profiles of other people and has made some friends and saved their profiles. He has also saved his favorite stores' profiles.

### Example 7

Terry clicks on offline shopping. Terry searches by location so he narrows down to Kent County to see all offline VIP sellers in Kent County. He sees a dentist who is a VIP seller offering a teeth cleaning just for VIPs for $50, the normal price is $140. Terry grabs the “VIP ticket” for $50 and enters his preferred day and time to come. The dentist office calls him to confirm the appointment. When Terry grabbed that $50 VIP ticket, $5 was paid immediately to Ms. Sherry who lives in Kentucky and is also a dentist. Sherry is the sister of the dentist in Kent County and she had put her brother in her business network. Terry comes home and writes the review, Terry gets $5 immediately. The dentist says “thanks,” and gives Terry a grade of A+.

### Example 8

Then, out of the blue, Terry gets an email from a VIP Seller based in Ohio. This seller has searched the VIP profiles by occupation and knows that Terry is a truck driver. This seller has a company that specializes in seat cushions made especially for Truck Drivers. Terry looked at the link to the VIP store of this manufacturer and really likes this and needs it for his long drives. Terry buys the cushion. As soon as Terry buys it, $5 is paid to Gourmet Chocolate in Germany. A person from that company was visiting Ohio a few months back and met the general manager of the cushion manufacturer at a bar in Ohio and told him about the inventive e-commerce website in routine conversation. The general manager liked the idea and joined as a seller by clicking on the link sent to him by the person who works at the Gourmet Chocolate in Germany. Terry loves the cushion and writes a review. Terry gets paid $5 for the review. If Terry was in somebody's VIP Network, then the VIP Network would have also got $5 right now, but Terry is not in anyone's VIP Network.

### Example 9

Terry is a seller who sells an all-natural hair spray to help people grow back their head-hair. He has great reviews. He is based in Indianapolis. Terry searches VIPs by keywords in their profile (like health, hair, balding, etc.) and emails them to introduce his product and read his reviews. Terry can also contact all VIPs in a given area, county, city, region, any way he wants, even any country. He can search them by all these options. Terry can do his own marketing campaigns, and see on his own business desk what was the success of that campaign. For example, Terry contacted 500 VIPs in July, and of those 500, 100 placed an order. So this campaign will show a success rate of 20%. Terry can see month by month how many campaigns he did and what were the success rates. When doing a new campaign, he can select the option that says: Only show VIPs who I have not contacted before or last x months. This is so he always gets fresh leads from all our VIPs.

Also, VIPs can blacklist any VIP or seller if they are bothering that VIP too much. Sellers can also blacklist any VIPs if they do not want to do business with that VIP.

### Example 10

When Terry created his VIP store, he could not find a category he needed out of the existing ones, so he put in a request for “Hair Thinning Spray—Cayenne.” This was created by the website administrator for Terry in the “customized categories” under letter H. In a VIP desk, a VIP has three shopping options of: online shopping, offline shopping, and customized categories. Customized categories allow sellers to sell unique items in unusual categories and also allows shoppers to find all kinds of things not found under common categories.

Terry has also found 93 sister merchants, these are spread across a few countries, and some are offline and some are online. For example, one of these 93 is a hair salon in Texas that has agreed to display Terry's spray on their counter to help Terry get sales. Terry has also agreed to sell the salon's cream on his VIP site.

Sister merchants may be a 100% free concept for all sellers to share customers, give each other leads, and display each other's products in each other's stores if they are in opposite ends of the USA or the world. When a seller creates a store, they are asked if they have interest in being a sister merchant. If they say “yes,” they will automatically always appear in search results when any seller is searching for potential sister merchants.

Terry searched the USA and other countries and found 93 he liked and wanted to partner with.

Terry has also found three OTGPs. They are based in Asia and Latin America. OTGPs are just people who are looking for things to sell in their own areas and want to use our sellers as a supply base. The OTGPs can help our sellers grow their sales a lot because OTGPs can be located in areas where nobody has Internet or very few people shop online. There will always be many millions and millions of people who do not want to shop online, do not care to go on the Internet, and are just too busy in life to even think about online shopping. OTGPs in such areas will help the sellers sell into new markets. This may also be a free service like sister merchants, and the two sides (OTGP and seller) agree to their own terms. In both sister merchants and OTGPs, the inventive website only helps them find each other, but then it is up to them to make their own deals and agreements.

### Example 11

Terry can be both a VIP and a seller. He only needs to create two separate accounts. Or if he sells both online and offline, he has to create three accounts. Let us say he sells the hair thinning spray online and has a car repair shop offline (he and his wife own it). Then he can have all three accounts free at the VIP site: (1) his VIP profile—he is a truck driver and can shop online and offline; (2) his online VIP store—he sells hair thinning spray; and (3) his offline VIP store—he issues VIP tickets for his car shop. He right now has issued 200 VIP tickets and so the VIPs can grab these. The VIP ticket he has on right now says “5 oil changes for $60. Normally these cost $29.99 but he is offering 5 for $60 which means $12 for 1 oil change.” The VIP can grab the ticket and them simply uses the ticket for all five oil changes (the ticket has tick boxes so the oil change place can initial each visit and write the date until all five boxes are ticked).

In above case, Terry has lots of income coming into his home thanks to the inventive e-commerce website: (1) his VIP Network—300 VIPs×3 reviews each per month=900 reviews×$5=$4500 per month; (2) his business network has 50 sellers who each average 100 sales per month, this means 5000 sales×$5=$25,000 per month; and (3) his car repair shop is selling the VIP tickets to VIPs because the VIPs get a better price and then get paid $5 for their reviews too! His hair thinning spray is selling well on his VIP site and also at 93 sister merchant locations and via the three OTGPs located in Brazil, Iraq and Malaysia. Let me also add that Terry has a wife and five kids (all above 18). This means there are seven people in the home. All seven can have their own VIP networks because each of these seven may have different friends, contacts, co-workers. So this is seven income streams into the household from their seven VIP networks.

### Example 12

Amy is in a bad situation. She has an abusive husband and has just left him. He was the only income earner so everything is in his name (home, car, etc.). Amy has taken herself and her five-year old daughter to the women's shelter in town. Amy has no car, no phone, no money, nothing. Her bank account is negative $200. Amy hears about the inventive e-commerce website and though she has no money to shop online, she understood the VIP network concept. She walked to the library to get on the Internet, and then she registered for free in a few minutes at the VIP site. She also sent her special invite link to some of her friends around the country, and some relatives too. Amy has 40 VIPs now in her VIP network. They make a purchase of an average of five times per month (they save money on pizza, haircuts, oil changes, etc., and get paid $5 for their reviews) which means 40×5=200 reviews submitted per month. Amy is making $5 from every review. She just made $1000 in her first month. Her bank account is now positive. She grew her VIP Network and also saved her money that comes in every month from her VIP network. Amy bought a good, used car and eventually opened her own VIP store selling her own hand-made artwork of client's baby photos. Amy is now doing great and has two income streams: (1) her VIP network (now at 90 VIPs from her word of mouth online); and (2) her custom arts VIP store. Amy is now making more income than the husband who would abuse her!

### Example 13

Charities may also take advantage of the website by becoming a VIP buyer or seller. For example, a church becomes a VIP buyer, and then asks all its members to join its VIP network so whenever a church member makes any purchase from the website, that church gets $5 every time.

### Example 14

A woman's shelter needs money for the abused wives and kids, and then they can join the website as both a VIP buyer and a seller. The shelter could simply offer some t-shirts to sell, but the main goal is they will have a business network and can invite any businesses across the USA and the world to join that shelter's business network, and every time those businesses make any sales to any VIP buyers, the shelter gets paid $5 from the website. And the shelter also may have a VIP network, and could simply put an ad in the local paper stating: “Please support our shelter to provide for the families staying with us. You can join the following website by going to this link and register for free. Then every time you make any purchase from any of the sellers at this site (online and offline), our shelter gets $5. Thanks for your support!”

### Example 15

A celebrity has millions of fans. He tells them on his fan page “hey I just joined this website, click on this link to be a part of my VIP network.” Let's say 5 million fans join his VIP network. Now every time those 5 million fans buy anything from the sellers at the website, the celebrity will get paid $5. The celebrity may use this as a way to raise money for charity by donating his or her earnings to one or more charities by taking advantage of their celebrity status. If those 5 million average four purchases a month (gas, food, gift, toys, diapers, etc.), that is 20 million purchases a month, and the celebrity gets $5 for each which means that the celebrity is making $100 million per month.

The inventive computer system is a unique distribution system for any revenue-generating organization to share its revenue with its own customers, clients, members. The following 17 features of the inventive computer system are all believed to be novel:

1. The feature of all shoppers (VIPs) having their own profiles.

2. The feature of being able to narrow down search results to region, state, county, city, ZIP code. This narrow down feature is available to all three types of users—VIPs, sellers and OTGPs.

3. The feature of being able to narrow down search results to product country of origin, such as products MADE IN USA or any other country for which the user has a preference.

4. The act of paying $5 to the parent seller who's business network the seller is in.

5. The act of paying the VIP $5 for his/her review on the recent purchase.

6. The act of a seller giving his/her customer a grade of A+, B, C or F on the recent purchase.

7. The wish system and how that encourages VIPs to maintain a good grade and also how it encourages sellers to grant wishes of VIPs to get introduced or promoted to the VIP whose wish they've granted and also to the VIP network that is owned by said VIP.

8. The feature of all sellers being able to search all shopper/VIP profiles using a variety of search options like occupation, interests etc. (there may be 14 or more options).

9. The feature of all sellers being able to do their own campaigns, track results and can also get select the option of getting fresh VIP results in every campaign. Fresh VIPs are those VIPs that will appear in search results that the sellers have not contacted in previous campaigns. The sellers can search VIP profiles by 14 options (the number of options could be increased or decreased at any time) and then refine results even more to region, state, county, city and ZIP code.

10. The feature of VIPs being able to blacklist any VIP or seller if they are bothering that VIP too much. Sellers can also blacklist any VIPs if they do not want to do business with that VIP.

11. All sellers can request a customized category be created for their products or services if our existing categories do not have what they need or if their offering is of such a unique nature or not common that it requires its own category.

12. The feature of sister merchants which is available to all interested sellers.

13. The feature of OTGPs which is available to all interested sellers.

14. The feature of VIP requests. If a VIP can't find a product or service they want, they can post a VIP request. Then all relevant sellers (relevant meaning they are of the same category the VIP has selected that is relevant to his/her VIP request) will get a “VIP Buy Notice” on their business desks that such and such VIPs are seeking x product or service. Sellers can respond and make offers direct to that VIP. There is also a central VIP requests area where all VIP requests are posted from newest to oldest, and here all sellers can browse the VIP requests, including those requests still not filled.

15. The feature of the POVC code. POVC means Proof-Of-Visit-Code. When a VIP buys something from an offline seller it means the VIP has “grabbed a VIP ticket” from the seller's store on our site. By grabbing, it means the VIP actually purchased that VIP ticket. The VIP then takes that VIP ticket to the offline establishment of the seller to get the product or service described on the VIP ticket. After the product or service has been provided to the VIP, the seller will give the VIP a special POVC code. This POVC code was automatically generated and sent to the seller at the same time, and the seller was notified that he/she has just had a VIP ticket grabbed by X VIP. The seller also received instructions that he/she must give this POVC code to the VIP only after the VIP has come to his/her establishment with the VIP ticket and received the product or service described on the VIP ticket. Then the VIP comes home and signs in to his/her VIP desk and goes to pending reviews. The VIP will then click on that particular pending review that is connected to this VIP ticket. When he clicks to open the review submission form, he will be told: “Please enter your POVC code.” The correct POVC code will open up the form, VIP will write the review, click submit and get paid $5 immediately (depends on how fast PayPal acts).

16. The feature for all sellers of “setting a minimum order requirement.” Every seller has the option to go into their store settings and set the minimum order they want to get. This is because sellers sell so many diverse products or services that have a very wide range of prices and profit margins. Some sellers will sell very low cost items with low, low profit margins while other sellers will sell items or services that are priced high or just one item and has a big profit margin. The sellers know that the checkout fee will be a flat, fixed fee of, for example, $20 so of course they will want to get an order of at least $25 (they get $5 since $20 was kept as the checkout fee). If the seller does not want to choose a minimum order setting, then the minimum setting is the default $25. But sellers can make this default higher for their own store to say $30, $35 all the way up to $1000. It just depends on each seller because some sellers may sell wine or paintings that start at $100 and they want to set the minimum setting at $200 meaning they know they will always get an order for at least two paintings or wine bottles. Other sellers sell low-priced $10 jeans and only make $5 profit per pair of jeans and they want to sell at least four pairs of jeans, so they set the minimum setting at $40. Sellers will be reminded in their store settings area to set the minimum order setting amount at the lowest they are willing to accept and not to set it too high because that will discourage VIPs from making a purchase.

17. The feature of helping all sellers pay their Paypal fees. For sellers who sign up during a pre-launch period, 100% of their Paypal fees would be paid on all orders up to $100 and 50% of their Paypal fees would be paid on all orders $100 to $200. This will save significant money to those sellers who sell a very high quantity of items (such as hundreds or thousands of units per month). For sellers who sign up after launch, 50% of their Paypal fees (fees associated with payment server 40) would be paid on all orders up to $200.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A computer system comprising:
a website server comprising a processor and a memory device, wherein said website server is configured to implement an e-commerce website and to interact with buyer web-enabled devices and seller web-enabled devices, and is configured to:
transmit data for a buyer profile input screen to a buyer's web-enabled device for display thereon;
receive buyer profile information from the buyer's web-enabled device and store the buyer profile information in said memory device;
transmit data for a listing of products/services for sale to the buyer's web-enabled device for display thereon;
receive a purchase order from the buyer's web-enabled device for a purchased product/service;
process the purchase order for the purchased product/service;
subsequently transmit data for a review input screen to the buyer's web-enabled device for display thereon, where the review input screen pertains to the purchased product/service;
receive a product/service review input on the purchased product/service from the buyer's web-enabled device; and
transmit instructions to a payment server for payment of a review payment to be made to the buyer for writing a review.

2. The computer system of claim 1, wherein a purchased product/service is at least one of an actual product and a ticket voucher for a product/service, wherein the ticket voucher for a product/service may be taken to an offline store to obtain the product/service.

3. The computer system of claim 2, wherein upon cashing in a ticket voucher, the buyer may obtain a POVC code that is entered into the buyer's web-enabled device, which transmits the POVC code to the website server, wherein the website server is further configured to receive the POVC code and to select the data for the review input screen that pertains to the purchased product/service prior to the step of transmitting the data for the review input screen.

4. The computer system of claim 1, wherein the listing of products/services for sale allows the buyer to search for products/services based upon a country of origin.

5. The computer system of claim 1, wherein said website server is further configured to:
enable the buyer to invite other buyers to join the e-commerce website whereby any buyers responding to an invite from the inviting buyer are identified in a network of the inviting buyer;
transmit data for listings of products/services for sale to buyer web-enabled devices for display thereon;
receive purchase orders from the buyer web-enabled devices for purchased products/services;
process the purchase orders for the purchased products/services;
subsequently transmit data for a review input screen to be displayed on each buyer web-enabled device that was used to purchase a product/service;
receive product/service reviews input on a purchased product/service from the buyer web-enabled devices; and
transmit instructions to a payment server for payment of a review payment to be made to the inviting buyer for each review written by a buyer in the inviting buyer's network.

6. The computer system of claim 1, wherein said website server is further configured to:
transmit data for a seller profile input screen to a seller's web-enabled device for display thereon;
receive seller profile information from the seller's web-enabled device and store the seller profile information in said memory device;
receive product/service information from the seller's web-enabled device;
cause a listing of products/services for sale of the seller's products/services to be displayed on the buyer web-enabled devices;
receive purchase orders from the buyer web-enabled devices for the seller's products/services;
process the purchase orders; and
charge a fixed fee to the seller for each purchase order of the seller's products/services.

7. The computer system of claim 1, wherein said website server is further configured to:
transmit data for a seller profile input screen to a seller's web-enabled device for display thereon;
receive seller profile information from the seller's web-enabled device and store the seller profile information in said memory device;
enable the seller to invite other sellers to join the e-commerce website whereby any sellers responding to an invite from the inviting seller are identified in a network of the inviting seller;
transmit data for listings of products/services for sale to be displayed on buyer web-enabled devices;
receive purchase orders from the buyer web-enabled devices;
process the purchase orders; and
transmit instructions to a payment server for payment of a seller referral payment to be made to the inviting seller for each purchase order from a seller in the inviting seller's network.

8. The computer system of claim 1, wherein said website server is further configured to:
transmit data for a buyer profile input screen to each buyer's web-enabled device for display thereon; and
receive buyer profile information from each of the buyer's web-enabled devices and store the buyer profile information in said memory device.

9. The computer system of claim 1, wherein said website server is further configured to:
permit sellers to access and search buyer profile information stored in said memory device using search criteria including at least one of: region, state, county, city, ZIP code, occupation, and interests.

10. The computer system of claim 1, wherein said website server is further configured to:
receive a buyer wish in the buyer's profile information, whereby a seller may access the buyer wish and grant the wish.

11. The computer system of claim 1, wherein said website server is further configured to:
receive a request for a product/service from a buyer that is not available in the listing of products/services; and
post the request such that it is accessible by sellers so that the sellers may offer such product/service to the buyer making the request.

12. A computer system comprising:
a website server comprising a processor and a memory device, wherein said website server is configured to implement an e-commerce website and to interact with buyer web-enabled devices and seller web-enabled devices, and is configured to:
transmit data for a buyer profile input screen to a buyer's web-enabled device for display thereon;
receive buyer profile information from the buyer's web-enabled device and store the buyer profile information in said memory device;
enable the buyer to invite other buyers to join the e-commerce website whereby any buyers responding to an invite from the inviting buyer are identified in a network of the inviting buyer;
transmit data for listings of products/services for sale to buyer web-enabled devices for display thereon;
receive purchase orders from the buyer web-enabled devices for purchased products/services;
process the purchase orders for the purchased products/services;
subsequently transmit data for a review input screen to each buyer web-enabled device that was used to purchase a product/service for display thereon;
receive product/service reviews input on a purchased product/service from the buyer web-enabled devices; and
transmit instructions to a payment server for payment of a review payment to be made to the inviting buyer for each review written by a buyer in the inviting buyer's network.

13. The computer system of claim 12, wherein said website server enables the inviting buyer to invite other buyers to join by generating a link that the inviting buyer may send to potential buyers, such that, when a potential buyer clicks on the link, the website server transmits data for a buyer profile input screen to a buyer web-enabled device of the potential buyer, and such that if the potential buyer joins by submitting a profile, the website server automatically considers that potential buyer as a buyer in the inviting buyer's network.

14. The computer system of claim 12, wherein said website server is further configured to:
transmit data for a seller profile input screen to a seller's web-enabled device for display thereon;
receive seller profile information from the seller's web-enabled device and store the seller profile information in said memory device;
receive product/service information from the seller's web-enabled device;
cause a listing of products/services for sale of the seller's products/services to be displayed on the buyer web-enabled devices;
receive purchase orders from the buyer web-enabled devices for the seller's products/services;
process the purchase orders; and
charge a fixed fee to the seller for each purchase order of the seller's products/services.

15. The computer system of claim 12, wherein said website server is further configured to:
transmit data for a seller profile input screen to a seller's web-enabled device for display thereon;
receive seller profile information from the seller's web-enabled device and store the seller profile information in said memory device;
enable the seller to invite other sellers to join the e-commerce website whereby any sellers responding to an invite from the inviting seller are identified in a network of the inviting seller;
transmit data for listings of products/services for sale to be displayed on buyer web-enabled devices;
receive purchase orders from the buyer web-enabled devices;
process the purchase orders; and
transmit instructions to a payment server for payment of a seller referral payment to be made to the inviting seller for each purchase order from a seller in the inviting seller's network.

16. A computer system comprising:
a website server comprising a processor and a memory device, wherein said website server is configured to implement an e-commerce website and to interact with buyer web-enabled devices and seller web-enabled devices, and is configured to:
transmit data for a seller profile input screen to a seller's web-enabled device for display thereon;
receive seller profile information from the seller's web-enabled device and store the seller profile information in said memory device;
receive product/service information from the seller's web-enabled device;
cause a listing of products/services for sale of the seller's products/services to be displayed on the buyer web-enabled devices;
receive purchase orders from the buyer web-enabled devices for the seller's products/services;
process the purchase orders; and
charge a fixed fee to the seller for each purchase order of the seller's products/services.

17. The computer system of claim 16, wherein said website server is further configured to:
enable the seller to invite other sellers to join the e-commerce website whereby any sellers responding to an invite from the inviting seller are identified in a network of the inviting seller;
receive product/service information from the seller's web-enabled devices of any sellers responding to an invite from the inviting seller;
transmit data for listings of products/services for sale by the sellers to be displayed on buyer web-enabled devices;
receive purchase orders from the buyer web-enabled devices;
process the purchase orders; and
transmit instructions to a payment server for payment of a seller referral payment to be made to the inviting seller for each purchase order from a seller in the inviting seller's network.

18. A computer system comprising:
a website server comprising a processor and a memory device, wherein said website server is configured to implement an e-commerce website and to interact with buyer web-enabled devices and seller web-enabled devices, and is configured to:
transmit data for a seller profile input screen to a seller's web-enabled device for display thereon;
receive seller profile information from the seller's web-enabled device and store the seller profile information in said memory device;
enable the seller to invite other sellers to join the e-commerce website whereby any sellers responding to an invite from the inviting seller are identified in a network of the inviting seller;
transmit data for listings of products/services for sale to be displayed on buyer web-enabled devices;
receive purchase orders from the buyer web-enabled devices;
process the purchase orders; and
transmit instructions to a payment server for payment of a seller referral payment to be made to the inviting seller for each purchase order from a seller in the inviting seller's network.

19. The computer system of claim 18, wherein said website server enables the inviting seller to invite other sellers to join by generating a link that the inviting seller may send to potential sellers, such that, when a potential seller clicks on the link, the website server transmits data for a seller profile input screen to a seller web-enabled device of the potential seller, and such that if the potential seller joins by submitting a profile, the website server automatically considers that potential seller as a seller in the inviting seller's network.

20. The computer system of claim 18, wherein said website server is further configured to:
prompt a seller for a grade for each buyer that purchases the seller's products/services;
receive and store each buyer grade in association with the buyer; and
permit access by the sellers to the buyer grades.
